(19) United States
(12) Patent Application Publication
(10) Pub. No.: US 2017/0119007 A1
(43) Pub. Date: May 4, 2017

(54) DEVICE AND METHOD FOR THE PRODUCTION OF CHOCOLATE SHELLS

(71) Applicant: Kraft Foods R & D, Inc., Deerfield, IL (US)

(72) Inventors: Thorsten Gustav, Deerfield, IL (US); Hannah Rymer, Deerfield, IL (US)

(21) Appl. No.: 15/301,926

(22) PCT Filed: Apr. 30, 2015
(86) PCT No.: PCT/IB2015/053161

§ 371 Date: Oct. 4, 2016

(30) Foreign Application Priority Data
May 2, 2014 (GB) 1407767.1

(51) Int. Cl. A23G 1/21; A23G 3/02; A23G 3/34; A23G 1/00; A23G 1/54

(52) U.S. Cl. CPC A23G 1/21; A23G 1/0076; A23G 1/545; A23G 3/0029; A23G 3/0263

(57) ABSTRACT

Improvements in and relating to production of chocolate shells Disclosed is a stamp (100), for use in a cold stamping operation, for insertion into a mould (200) along an insertion axis (180), the stamp (100) comprising a first tapering portion (110) arranged to deviate from the insertion axis (180) at a first angle and to be substantially parallel with a corresponding internal surface (210) of the mould (200), and a second tapering surface (130) arranged to deviate from the insertion axis (180) at a second angle, greater than the first angle, such that, in use, when the stamp (100) is inserted into the mould (200), an aperture is formed around a rim of the mould (200) which is smaller than a distance between the first tapering portion (110) and the corresponding internal surface (200) of the mould (200).

### FIELD OF THE INVENTION

The present invention relates to the production of edible shells for use in the production of confectionery products. In particular, it relates to the production, using cold stamping techniques, of chocolate shells comprising inclusions—solid components such as caramel pieces, toffee pieces, chocolate pieces, fruit, chopped nuts, biscuit pieces, candy or the like.

### BACKGROUND TO THE INVENTION

One known technique used to form confectionery shells uses a so-called turning station or inversion method where molten chocolate mass is added to a mould which is vibrated to remove air bubbles and simply turned through 180°, allowing excess chocolate to drip out and be recycled. However, the use of such a technique to form shells having inclusions therein poses several problems. The excess or overflow mass having inclusions within it is difficult to recycle and re-temper using existing production facilities and so requires extensive and re-work.

Also, shells produced in this way do not have a uniform thickness, especially when the shell material has relatively high viscosity. This can impose restrictions on the composition (e.g. fat content) of the shell material.

There is, however, a desire to produce shells incorporating inclusions, since this can enable a greater range of confectionery products to be produced, possibly appealing to different markets and customers.

It is an aim of embodiments of the present invention aim to produce confectionery shells comprising inclusions of the form set out above, and others.

### SUMMARY OF THE INVENTION

According to a first aspect of the present invention, there is provided a stamp, for use in a cold stamping operation, for insertion into a mould along an insertion axis, the stamp comprising a first tapering portion arranged to deviate from the insertion axis at a first angle and to be substantially parallel with a corresponding internal surface of the mould and a second tapering surface arranged to deviate from the insertion axis at a second angle, greater than the first angle, such that, in use, when the stamp is inserted into the mould, an aperture is formed around a rim of the mould which is smaller than a distance between the first tapering portion and the corresponding internal surface of the mould.

In one embodiment, the second tapering surface deviates from the insertion axis in the range of 15-75°.

In one embodiment, there is provided a complementary mould, wherein the mould has a internal surface arranged to substantially parallel with the first tapering portion of the stamp.

In one embodiment, when the stamp is fully inserted into the mould, a gap is formed between the stamp and the mould to allow excess chocolate mass to be expelled.

In one embodiment, the gap formed is substantially in the range of 0.1 mm to 2 mm.

According to a second aspect of the present invention, there is provided a cold stamping method for producing a chocolate shell, comprising the steps of: providing a mould; providing a mixture of molten chocolate and inclusions into the mould; and inserting a stamp into a mould along an insertion axis, the stamp being arranged such that it comprises a first tapering portion arranged to deviate from the insertion axis at a first angle and to be substantially parallel with a corresponding internal surface of the mould and a second tapering surface arranged to deviate from the insertion axis at a second angle, greater than the first angle; and when inserted to a pre-defined depth, an aperture is formed between the stamp and the mould which is smaller than a major part of the chocolate shell, such that the inclusions in the mixture are forced to occupy the major part of the shell and any excess material which escapes from the mould is substantially free of inclusions.

In one embodiment, the step of providing inclusions includes selecting inclusions of a diameter no greater than 75% of the thickness of the major part of the shell.

According to a third aspect of the present invention, there is provided a chocolate shell comprising inclusions, the chocolate shell having a major part and a rim, wherein the major part is thicker than the rim and the rim is substantially free of inclusions.

In one embodiment, the inclusions have a maximum diameter of 75% of the thickness of the major part of the chocolate shell.

### BRIEF INTRODUCTION TO THE FIGURES

For a better understanding of the invention, and to show how embodiments of the same may be carried into effect, reference will now be made, by way of example, to the accompanying diagrammatic drawings in which:

FIGS. 1a and 1b show a cold stamping apparatus and process according to an embodiment of the present invention; and

FIG. 2 shows the resultant shell, according to an embodiment of the present invention.

### DETAILED DESCRIPTION OF EXAMPLE EMBODIMENTS

It is known in the field of confectionery manufacture to produce edible shells which can then be back-filled with various possible fillings before being closed by one of various techniques to seal the filling in the shell. A particular technique used to reliably produce shells from molten chocolate mass is cold stamping, which is well known in the art. The technique involves the delivery of a metered quantity of molten chocolate mass into a mould and, while the chocolate mass is still molten, a chilled stamp or die is introduced into the mould. Since the die is chilled, the molten mass solidifies quickly, creating a chocolate shell having accurate weight, regular geometry, and uniform wall thickness. The entire process is highly susceptible to automation and allows the accurate and reliable production of many shells in a relatively short time.

It is not known to use cold-stamping techniques to produce confectionery shells having inclusions contained therein. It is believed that this has not been considered by those skilled in the art or that there is a prejudice against it for reasons which embodiments of the present invention overcome or at least ameliorate.

In prior art cold stamping processes, once a chocolate shell has been produced, it is usual to scrape the exposed surface of the mould tray to remove any excess chocolate present surrounding the opening of the shell. The mould tray typically includes a plurality of cavities, each having a shell formed therein. The scraping process involves passing a blade across the mould tray to scrape away any excess chocolate, which protrudes above the surface of the mould tray.

A problem with shells having inclusions therein is that the scraping process can tend to damage the rim of the shells, since the inclusions can tend to cause the chocolate to break away in a less controlled way than in the case where the shells are formed solely from chocolate i.e. without any inclusions. For instance, in a shell consisting solely of chocolate, any excess can be scraped away cleanly, to leave a distinct edge on the shell. If the excess chocolate, comprising inclusions is scraped away, then as the inclusions are removed by the scraping blade, it can create pits or recesses in the rim of the shell.

An alternative process which may be used to remove excess chocolate mass is to use a so-called “licking rollers. This process involves passing a chilled metal roller over the mould, so that any excess chocolate sticks to the roller and is thereby removed from the mould. The process cannot be used on chocolate which has inclusions, since the roller will simply smash the inclusions, rather than adhere to or absorb them. Chocolate mass with inclusions does not, in any event adhere well to such a roller.

This damage to the rims can result in shells which fail an aesthetics test i.e. they simply look ‘bad’ and unattractive to the consumer. Furthermore, the excess chocolate with inclusions which is scraped away can damage other shells in the mould tray by being dragged across them by the scraping blade. Furthermore, any damage to the rims of the shells can lead to incomplete closure of the product during backing off, which may result in the filling leaking out. These problems or perceived problems are believed to contribute, at least in part, to the reluctance to produce shells comprising inclusions, using cold stamping processes.

Embodiments of the present invention allow cold stamping techniques to be used to create shells comprising inclusions, such that the rims of the shells are arranged such that any inclusions are substantially constrained within the shell and are less susceptible to protruding above the open surface of the mould tray.

Naturally, the inclusions present in the molten chocolate vary in terms of both shape and size. In the case of biscuit pieces or chopped nuts, the inclusions are formed by processing a precursor material, and it is not always feasible to attempt to accurately control the size of the pieces formed. However, within certain margins, it is possible to know the approximate average size of the inclusions, as well as upper and lower limits of the inclusion specification.

In order to manufacture the shells with inclusions, the molten chocolate is mixed with the inclusions and a metered dose is added to a mould 200. In a typical automated process, a mould tray comprising a plurality of moulds 200 is provided, and a metered dose is added to each mould 200 in the tray. The mass with inclusions is then vibrated to remove or at least minimise air bubbles in the mixture.

Once each mould 200 has been provided with the chocolate/inclusion mix, a refrigerated stamp or die 200 is introduced into the mould 100. The precise parameters of the cold stamping process can be selected according to the specification of chocolate used in the process. However, as an example, the cooling agent temperature may be set at −12° C., which leads to the cold stamp having a temperature of −9° C. The stamp has a speed of 60 mm/s and the overall time of the stamping process is 3 s.

Embodiments of the invention may be configured to produce a range of different shell thicknesses. For instance, depending on the effect to be achieved, the shell thickness may be set to lie in the range of approximately 0.6 mm to 10 mm. The thickness can be varied by altering the relative sizes of the stamp and mould. The greater the distance between the external surface of the stamp and the internal surface of the mould, when the stamp is fully inserted, the thicker the resultant shell.

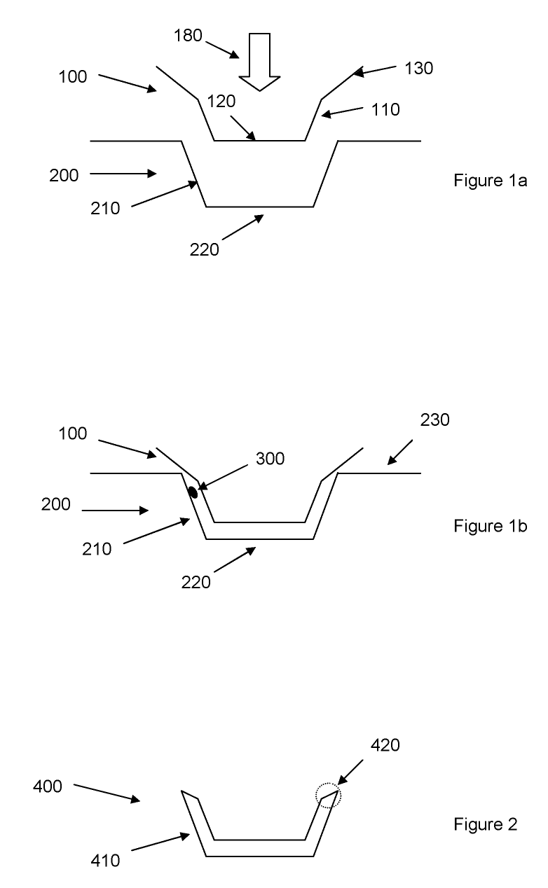

FIG. 1a shows the situation after the mix has been added to the mould 200, and before the stamp 200 is introduced. Note that the chocolate/inclusion mix has been omitted for clarity purposes but, at this stage, it sits in the bottom of the mould 200.

The mould 200 is in the form of a recess having a tapered wall 210, arranged such that the opening of the mould is wider than the base 220, thereby allowing the shells which are produced to be removed easily. The mould can be arranged to have any shape required e.g. circular, rectangular, triangular or irregular, provided that the wall 210 is tapered to allow removal. The tapered wall deviates from the vertical by a few degrees—sufficient to allow the shell to be removed from the mould without difficulty.

The tapered wall can be arranged in any suitable shape or configuration. For instance, the wall can appear to be circular in plan view, in which case the wall 210 comprises only one circular wall. However, the wall 210 can appear to be square or rectangular, in which case, the tapered wall 210 comprises four individual wall parts, arranged at rights to its neighbour. Other geometric or seemingly random shapes can also be devised.

The stamp 100, according to an embodiment of the present invention has a shape which generally conforms to the shape of the mould, albeit slightly smaller. The relative sizes of the mould and the stamp dictate the thickness of the shell which is produced. In particular, the thickness of the shell which is produced is equal to the gap between the outer surface of the stamp and the inner surface of the mould. It is this gap into which the molten chocolate flows once the stamp is introduced into the mould.

The stamp, according to an embodiment of the invention, comprises a base 120 which is substantially parallel with the base 220 of the mould. It also has a first tapering section 110, running from the base 120, which generally conforms to the tapering walls 210 of the mould. The first tapering section 110 deviates from the vertical to the same or similar extent to the tapered sides 210 of the mould.

Extending from the top of the first tapering section 110 is a second tapering section 130, which deviates from the vertical to a greater extent than the first tapering section. As the stamp is introduced into the mould, the chocolate/inclusion mix is forced to flow around the stamp to occupy the space between the stamp and the mould. This is shown in FIG. 1b, which shows the stamp 100 at its furthest insertion into the mould 200.

The inclusions in the mix are represented by a single inclusion 300. In practice there would be a great many more inclusions in the mix, having a range of different sizes. Where possible, their general dimensions are selected so that they are able to be fully accommodated within a thickness of chocolate shell determined by the gap between the stamp and mould.

A typical inclusion is a “sugar pearl”. This may be specified to have a maximum inclusion size of 1.4 mm and a minimum inclusion size of 0.4 mm, with an average inclusion size of 0.8 mm. The inclusion size is obtained by sieving the sugar pearl inclusions prior to adding them to the chocolate mass.

If the shell is made to lie in the range 0.6 mm to 10 mm, as set out previously, then typically, inclusions will lie in the range 0.2 mm to 8 mm (diameter). Clearly, the largest diameter of inclusion must be smaller than the shell thickness or the inclusion will be crushed by the stamping process and/or protrude through the shell. In general, if the maximum diameter of the inclusion is chosen to be no more than 75% of the maximum shell thickness, this is found to be acceptable. For example, if a shell has a maximum thickness of 4 mm, then the maximum diameter of inclusion should be 3 mm.

As the stamp is introduced to the mould, along an insertion axis, indicated by the arrow 180, the mixture of molten chocolate plus inclusions is forced to occupy the gap between the stamp and the mould. By “fully inserted”, it is meant that the stamp is inserted into the mould to the depth required to produce the desired shell. It does not mean that the stamp is inserted physically as far as is possible, since this would not produce the desired shell.

The effect of the second tapering section 130 is to produce a narrow outlet through which this excess chocolate can escape, but which is selected to be sufficiently narrow to prevent inclusions 30 from escaping therethrough. The metered dose of chocolate plus inclusions which is introduced into the mould in the first instance is arranged such that the volume of chocolate plus inclusions is substantially identical with the amount required to form a shell so that as little chocolate as possible escapes. However, it is generally preferable to have a small excess of chocolate provided, as otherwise, if there is too little chocolate mixture, the resultant shell is almost guaranteed to be malformed, since it will be missing some mass. Also, the provision of a small amount of excess chocolate mass allows for air removal, as any residual air will tend to ne expelled with the excess chocolate mass.

Previously, a typical set of parameters was disclosed. However, in more general terms, the parameters of the stamping process may vary, depending on the chocolate mass, the nature of the inclusion, and the size of the shell to be produced, among other variables. Typical ranges are: stamp temperature of −30° C. to +6° C.; and stamping time of 0.1 s to 7 s

The second tapered portion of the stamp may lie in the range of 15° to 75° from the insertion axis, so as to produce a spacing at the top of the mould in the range of 0.1 mm to 2 mm, thereby allowing chocolate mass to escape, but without allowing inclusions to leave.

As can be seen from FIG. 1b, as the stamp is introduced into the mould, any inclusions in the mix towards the upper part of the mould will tend to be pushed down into the thicker part of the shell, as the upper part of the shell is forced into a narrower configuration. The second tapering portion 130 effectively restricts any inclusions from escaping through the narrow gap and so out of the top of the mould, and has the effect of forcing any inclusions in that region of the shell to be forced downwards into the relatively thicker part of the shell.

It is found that by providing the second tapering portion, rather than a sudden or abrupt change in stamp dimension, any inclusions in the upper portion of the mould are pushed down into the shell, rather than being crushed, which would otherwise happen.

Once the chocolate/inclusion mix has solidified and the stamp is withdrawn, the bulk of the inclusions will be positioned within the thicker or major part 410 of the shell. The actual rim area 420, i.e. the area surrounding the opening to the completed shell, is significantly thinner than the rest of the shell. This is shown in FIG. 2, which shows a completed shell 400, once removed from the mould. The rim area 420 is significantly thinner than the rest of the shell and includes substantially no inclusions, as these have been forced into the major part 410, during the cold stamping process.

In this way, if a scraper is required—as it usually is—to remove any excess chocolate which has been forced out, as described, it will be substantially free of inclusions, since these have been retained within the major part 410 of the shell 400. This has the advantage that a relatively clean break between the excess chocolate and the rim can be achieved, and that any excess chocolate which is so scraped away is less likely to damage other shells in the moulds than excess chocolate containing inclusions such as nuts, which are relatively sharp and hard.

Embodiments of the present invention allow a chocolate shell comprising inclusions to be produced, avoiding the problems or perceived problems inherent in the prior art. In particular, the inclusions in the molten mixture can be forced to occupy the shell and any excess chocolate which is freed from the mould as part of the stamping process is substantially free from inclusions, allowing it to be scraped away without damaging the delicate rim of other shells in the mould tray. Furthermore, the excess chocolate which is so removed may be re-worked, minimising wastage.

Throughout this specification, exemplary embodiments have referred to molten chocolate mass as the material from which the shell is formed, However, the skilled person will realise that other edible material can be used to produce the desired confectionery shell and the moulding conditions (e.g. temperatures) may be selected accordingly.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A stamp, for use in a cold stamping operation, for insertion into a mould along an insertion axis, the stamp comprising a first tapering portion arranged to deviate from the insertion axis at a first angle and to be substantially parallel with a corresponding internal surface of the mould and a second tapering surface arranged to deviate from the insertion axis at a second angle, greater than the first angle, such that, in use, when the stamp is inserted into the mould, an aperture is formed around a rim of the mould which is smaller than a distance between the first tapering portion and the corresponding internal surface of the mould.

2. The stamp as claimed in claim 1, wherein the second tapering surface deviates from the insertion axis in the range of 15-75°.

3. The stamp of claim 1, further comprising a complementary mould, wherein the mould has a internal surface arranged to substantially parallel with the first tapering portion of the stamp.

4. The stamp of claim 3, wherein when the stamp is fully inserted into the mould, a gap is formed between the stamp and the mould to allow excess chocolate mass to be expelled.

5. The stamp of claim 4 wherein the gap formed is substantially in the range of 0.1 mm to 2 mm.

6. A cold stamping method for producing a chocolate shell, comprising the steps of: providing a mould;
providing a mixture of molten chocolate and inclusions into the mould; and
inserting a stamp into a mould along an insertion axis, the stamp being arranged such that it comprises a first tapering portion arranged to deviate from the insertion axis at a first angle and to be substantially parallel with a corresponding internal surface of the mould and a second tapering surface arranged to deviate from the insertion axis at a second angle, greater than the first angle; and
when inserted to a pre-defined depth, an aperture is formed between the stamp and the mould which is smaller than a major part of the chocolate shell, such that the inclusions in the mixture are forced to occupy the major part of the shell and any excess material which escapes from the mould is substantially free of inclusions.

7. The method of claim 6 wherein the step of providing inclusions includes selecting inclusions of a diameter no greater than 75% of the thickness of the major part of the shell.

8. A chocolate shell comprising inclusions, the chocolate shell having a major part and a rim, wherein the major part is thicker than the rim and the rim is substantially free of inclusions.

9. The chocolate shell of claim 8 wherein the inclusions have a maximum diameter of 75% of the thickness of the major part of the chocolate shell.
